(19) United States
(12) Patent Application Publication
(10) Pub. No.: US 2007/0271342 A1
(43) Pub. Date: Nov. 22, 2007

(54) METHODS AND SYSTEMS TO DELIVER ELECTRONIC MAIL USING PAYMENTS

(75) Inventors: Jeff Brandt, Cedar Park, TX (US); Philip Kortum, Houston, TX (US); Marc Sullivan, Austin, TX (US)

Correspondence Address: HANLEY, FLIGHT & ZIMMERMAN, LLC, 150 S. WACKER DRIVE, SUITE 2100, CHICAGO, IL, 60606, US

(73) Assignee: SBC Knowledge Ventures, L.P., Reno, NV (US)

(21) Appl. No.: 11/419,401

(22) Filed: May 19, 2006

(51) Int. Cl. G06F 15/16

(52) U.S. Cl. 709/206

(57) ABSTRACT

Methods, apparatus, and systems to deliver electronic mail using payments are disclosed. An example method involves receiving an electronic mail message at a server. It is then determined whether the electronic mail message includes information indicative that a sending entity has posted an electronic mail delivery payment to enable delivery of the electronic mail message. When the electronic mail message includes the information indicative that the sending entity has pasted the electronic mail delivery payment, a funds account of an intended recipient of the electronic mail message is polled to determine whether the electronic mail delivery payment has been deposited in the funds account. The electronic mail message is not sent to a mailbox of the intended recipient unless the electronic mail delivery payment has been deposited in the funds account regardless of whether the sending entity is on a permissions list.

### FIELD OF THE DISCLOSURE

The present disclosure relates generally to electronic mail systems and, more particularly, to methods and systems to deliver electronic mail using payments.

### BACKGROUND

As the Internet grows in popularity, more and more people have adopted it as a standard medium for communicating with other people. Specifically, many people and companies have turned to the Internet for sending and receiving mail in the form of electronic mail (“e-mail”) for personal and business purposes. Unlike standard paper mail, which can take days to arrive at its destination, e-mail is delivered almost instantaneously. Also unlike standard paper mail, e-mail is virtually free. That is, aside from the cost of an Internet connection and, in some cases, the cost of an e-mail account with an Internet service provider (“ISP”), people can send e-mails at no cost while reaping the benefits of virtually instantaneous communication.

Although e-mail has many benefits, some have exploited those benefits for purposes that are otherwise an annoyance, malignant, or a burden on many e-mail users. For example, companies that once delivered advertisements or promotional marketing materials via standard paper mail are greatly benefited by the virtually free e-mail technology. Companies no longer need to spend money on postage to market their products, and the low cost associated with e-mail has encouraged many companies to increase their target audience and send virtually unlimited e-mails. Telemarketing companies that once conducted business almost entirely via costly local, toll, and long-distance telephone calls can turn to e-mail as a lower-cost alternative to reach their audiences and in many cases expand their target audience.

Marketing and advertising type e-mails are typically referred to as spam e-mail. Spam e-mails are often sent in large quantities and in some cases are sent with little or no regard as to whom they are addressed. That is, because of the relatively low cost of e-mail, many companies or individuals often send mass e-mailings using large e-mail listings without incurring much cost, if any. Spam e-mail is often annoying to recipients because they tend to fill recipient e-mail inboxes quickly and are often of little or no interest. In addition, spam e-mail is a burden on networks and ISP's because of the bandwidth required to deliver the large amounts of spam e-mail and the data storage space required to store the spam e-mails. Spam e-mails are not limited to marketing and advertising type e-mails, but also include malignant e-mails (e.g., virus-carrying e-mails, phishing e-mails, etc.).

Some spam e-mailers (e.g., users, companies, etc.) do not use valid e-mail addresses to send e-mails. That is, some spammers create several (e.g., hundreds) e-mail addresses for the mere purpose of sending spam e-mails. In this case, recipients have no way of tracking down senders or requesting removal from spam lists.

### BRIEF DESCRIPTION OF THE DRAWINGS

FIG. 1 depicts an example network system for sending electronic mails (“e-mails”) using payments.

FIG. 2 depicts an example payment request message notifying an e-mail sender that a payment is required to send an e-mail message.

FIG. 3 depicts an example apparatus for sending e-mails using payments.

FIG. 4 is a flowchart representative of machine readable instructions that may be executed to implement the example apparatus of FIG. 3.

FIG. 5 is a flowchart representative of machine readable instructions that may be executed to enable an e-mail recipient to grant or withhold refunding of payment to an e-mail sender.

FIG. 6 is a block diagram of an example processor system that may be used to execute the example machine readable instructions of FIGS. 4 and 5 to implement the example systems and/or methods described herein.

### DETAILED DESCRIPTION

The example methods, systems, and/or apparatus described herein may be used to deliver electronic mail (“e-mail”) using payments. The example methods, systems, and/or apparatus may be implemented by Internet service providers (ISP's) (e.g., telephone companies, cable companies, satellite communication companies, wireless mobile communication companies, utility companies, telecommunication companies, dedicated Internet providers, etc.) to protect themselves and/or subscribers against spam e-mail. Spam e-mail is often used for mass deliveries of unsolicited, unwanted, and nuisance e-mails. Spam e-mail can also be used to commit fraud and/or identity theft, and/or to deliver harmful viruses. For example, in “phishing” scams, unscrupulous individuals and/or entities may use spam e-mail to lure unsuspecting recipients to provide personal, financial, highly sensitive, etc. information such as, for example, bank account information, social security information, personal identification information, etc.

Spam e-mail is not only an annoyance to e-mail recipients, but it can be detrimental to communication networks by using up network bandwidth and/or data storage space. Some known methods of controlling span e-mail use optional postage payments in combination with permissions lists or white lists (i.e., a list having names and/or e-mail addresses of senders from which a recipient will accept e-mails) to allow or block delivery of e-mails to intended recipients. For example, in a known system, if an e-mail server receives an e-mail addressed to a particular user, the e-mail server may determine whether the e-mail is accompanied with the optional postage payment, and if so, deliver the e-mail to the intended recipient. However, if the received e-mail is not accompanied with the optional postage payment, the e-mail server checks the permissions list of the intended recipient. If the recipient's permissions list has the e-mail address of the e-mail's sender, then the e-mail server forwards the e-mail to the intended recipient.

The drawback of the above-described known systems is that those systems encourage e-mail spammers to randomly generate or acquire more and more recipient e-mail addresses and to send out more and more e-mail messages. In this manner, even if the e-mail spammers do not attach any postage payments, the more e-mail messages the spammers send the greater the likelihood that a substantial percentage of those e-mails will be delivered to intended recipients because at least some of the randomly generated or acquired recipient e-mail addresses will be on recipient permissions lists. Additionally, to acquire valid recipient e-mail addresses, the above-described methods encourage spammers to infiltrate e-mail address books or contacts lists stored on user computers and/or network servers and to send out e-mail worms that will propagate e-mails using e-mail addresses found in other people's e-mail address books and contacts lists. Also, spammers may use techniques to breach recipient permissions lists to acquire valid e-mail addresses that will enable delivery of spam e-mail.

Unlike known systems, the example methods, systems, and apparatus described herein deliver e-mail messages to recipients only if senders of the e-mail messages post a required postage payment for delivery of the e-mail messages. That is, if a sender does not provide the required postage payment to a deposit account of the intended recipient, an e-mail server will not deliver the e-mail message to the intended recipient regardless of whether the sender's e-mail address or other identification appears on a permissions list of the intended recipient.

An example method involves receiving an e-mail message via a server and determining via the server whether the e-mail message includes information indicative that a sending entity (e.g., an e-mail sender) has posted an e-mail delivery payment (e.g., a monetary value) to enable delivery of the e-mail message. If the e-mail message includes the information indicating that the sending entity has posted the e-mail delivery payment, then the server polls a funds account (e.g., a bank account, an Internet payment system account, PayPal®, etc.) of an intended recipient of the e-mail message to determine whether the e-mail delivery payment has been deposited in the funds account. If the e-mail delivery payment has not been deposited in the funds account, the server does not send the e-mail message to a mailbox of the intended recipient regardless of whether the sending entity is on a permissions list of the intended recipient. Because e-mails are not forwarded to intended recipients unless an e-mail delivery payment has been deposited, spammers will be discouraged from sending mass e-mails without payments because none will be delivered.

In an example implementation, when the server determines that an e-mail delivery payment has been deposited into a funds account of an intended recipient, the server forwards the corresponding e-mail to the mailbox of the intended recipient. In some example implementations, a rule may be implemented to require the server to verify that the deposited payment is available for withdrawal (e.g., the e-mail delivery payment is not subject to insufficient funds or fraudulent activity on behalf of the e-mail sender such as stolen credit card activity) before forwarding the e-mail to the intended recipient. Verifying that the deposited payment is available for withdrawal by the intended recipient ensures that the recipient can obtain the funds associated with the e-mail delivery payment and use the funds for purposes other than sending e-mail messages (e.g., purposes other than to provide e-mail delivery payments). For example, the payment may be withdrawn as cash currency by the recipient to spend on whatever the recipient desires.

In addition, the server may verify that the deposit is sufficient by determining whether the amount of the e-mail delivery payment is equal to or greater than a threshold monetary value associated with sending the message to the intended recipient. That is, recipients may set a minimum e-mail delivery payment amount (e.g., a threshold monetary value) that they require a sender to post to enable delivery of e-mail messages. In some example implementations, recipients may set different threshold values for known e-mail sender (e.g., family, friends, financial institutions, utility companies, etc.) and for unknown e-mail senders (e.g., companies with whom a recipient has no ongoing relationship, marketing companies, spammers, etc.). Also, after receipt of an e-mail for which a payment has been provided, the recipient may refund some or all of the payment to the sender. Accordingly, friends and family can often be assured that the recipient will refund all of the payment, while businesses, telemarketers, etc. may assume the risk that the recipient will not refund any of the payment even if the recipient does read the e-mail.

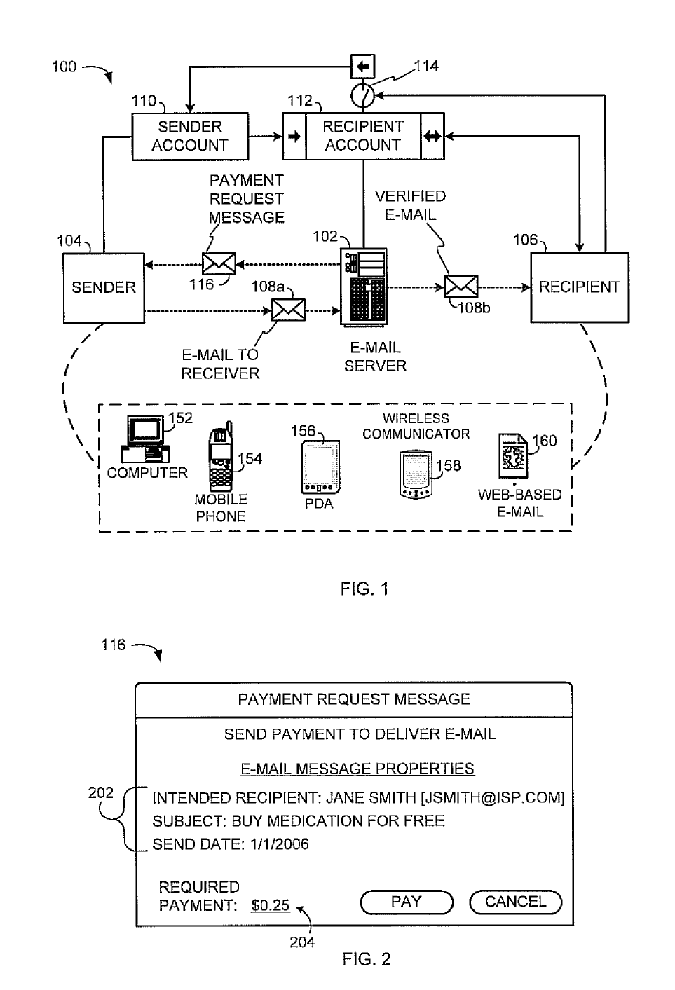

Turning to FIG. 1, an example network system 100 for sending e-mails using payments includes an e-mail server 102 accessible by an e-mail sender 104 (e.g., a person, a company, a spammer, etc.) and an e-mail recipient 106 (e.g., an intended recipient). The e-mail sender 104 and the e-mail recipient 106 may access their e-mail accounts using any e-mail access medium configured to be communicatively coupled to the e-mail server 102 such as, for example, a computer terminal 152, a mobile phone 154, a personal digital assistant 156, a wireless communicator 158, a web-based e-mail service 160, etc. to send and/or receive e-mails. When the sender 104 sends the e-mail 108a to the recipient 106, the e-mail 108a is first delivered to the e-mail server 102. The sender 104 can also post an e-mail delivery payment from a sender account 110 to a recipient account 112. As shown in FIG. 1, the sender account 110 can only deposit payments into the recipient account 112. That is, the sender 104 cannot withdraw payments from the recipient account 112. However, payments deposited into the recipient account 112 can be refunded or returned to the sender account 110 via a refund mechanism 114, if the recipient 106 indicates that the payment should be returned. For example, the recipient 106 may typically want to refund e-mail delivery payments to family and friends, but may not want to refund payments to marketing companies and solicitors.

The e-mail server 102 is configured to determine whether the e-mail 108a includes information indicating that the sender 104 has posted an e-mail delivery payment to the recipient account 112. The e-mail server 102 is also configured to verify or confirm that the payment has actually been deposited in the recipient account 112 and/or is available for withdrawal by the recipient 106. If the e-mail server 102 verifies that the e-mail delivery payment has been deposited in the recipient account and/or is available for withdrawal by the recipient 106, the e-mail server 102 will indicate that the e-mail 108a is a verified e-mail 108b (e.g., a validated e-mail) and will forward the verified e-mail 108b to a mailbox of the recipient 106 so that the recipient 106 can retrieve the verified e-mail 108b.

On the other hand, if the e-mail server 102 determines that the e-mail delivery payment has not been deposited in the recipient account 112 or that an e-mail delivery payment deposited in the recipient account 112 is not sufficient, the e-mail server 102 will not forward the e-mail 108a to the mailbox of the recipient 106. Instead, the e-mail server 102 of the illustrated example will generate a payment request message 116 and forward the payment request message 116 (shown in detail in FIG. 2) to the sender 104 (e.g., to a mailbox of the sender 104) informing the sender 104 that an e-mail delivery payment or a greater amount of an e-mail delivery payment than what was deposited is required to deliver the e-mail 108a. In this manner, if the sender 104 wishes for the recipient 106 to receive the e-mail 108a, the sender 104 can deposit the appropriate amount of funds in the recipient account 112. E-mail spammers will not likely be willing to spend the e-mail delivery payment to ensure receipt of the e-mail 108a by the recipient 106, and thus, will not provide the required e-mail delivery payment. If an e-mail spammer has created e-mail accounts for the sole purpose of sending spam e-mail, the spammer may not ever check the inboxes of those e-mail accounts. Therefore, the required e-mail delivery payment will never be provided and the recipient 106 will not be bothered with the spam e-mail.

FIG. 2 depicts an example payment request message 116 notifying the e-mail sender 104 that a payment is required to deliver the e-mail 108a. The payment request message 116 may be implemented using an e-mail or any other type of messaging medium. As shown, the example payment request message 116 provides e-mail identification information 202 to identify the e-mail 108a (FIG. 1). The payment request message 116 also indicates the required payment amount 204. Upon receipt of the payment request message 116, the sender 104 may elect to pay or to cancel delivery of tie e-mail 108a. If the sender 104 ignores the payment request message 116 or takes no action, the e-mail server 102 (FIG. 1) will discard or delete the e-mail 108a.

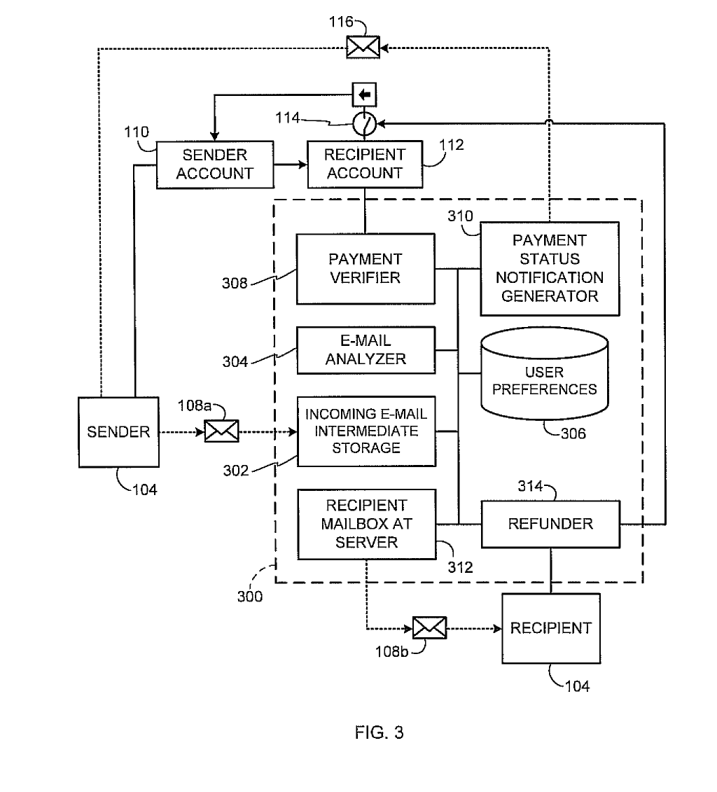

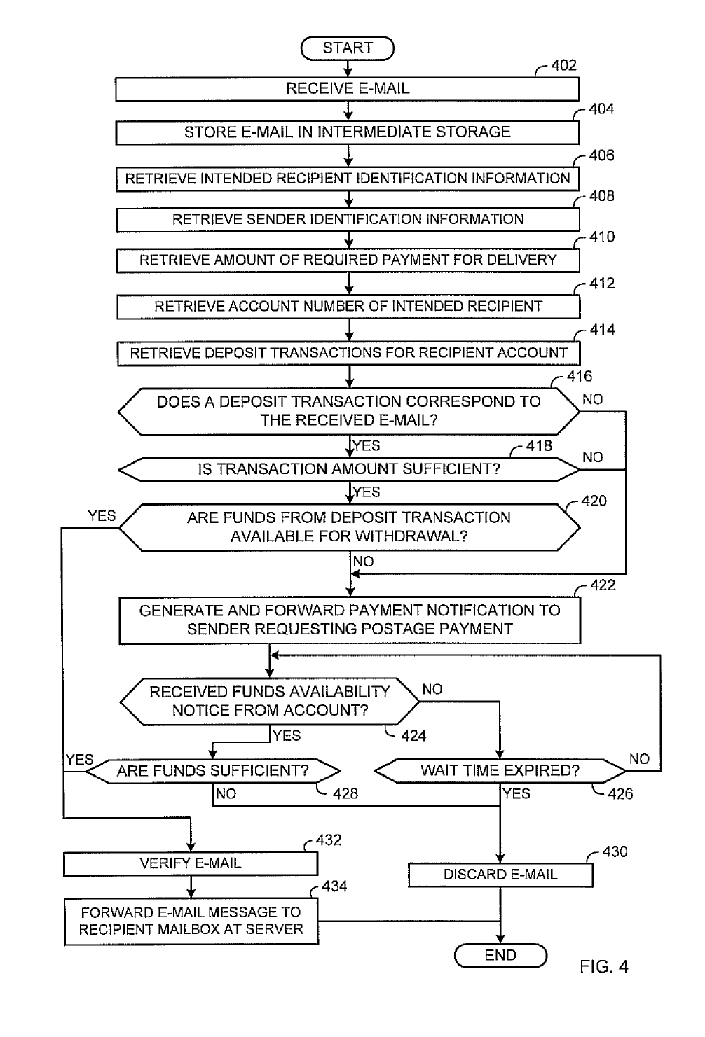

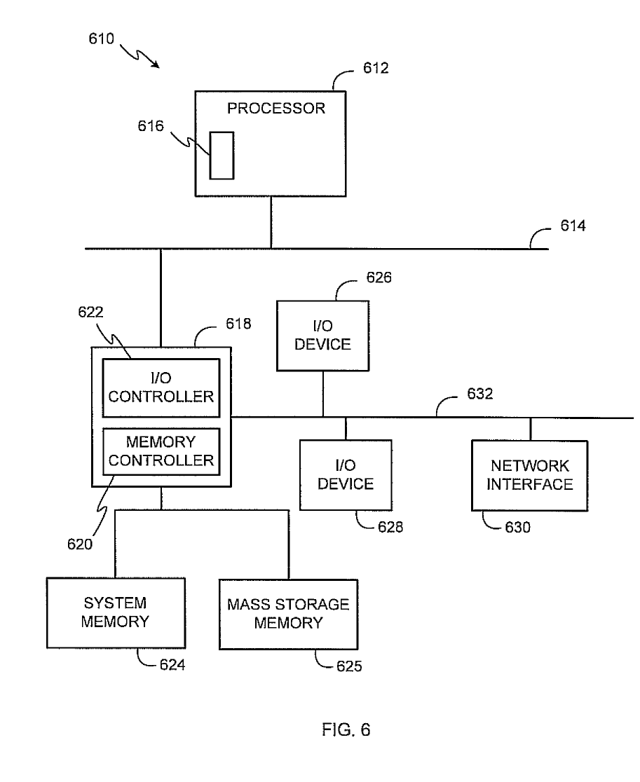

FIG. 3 is a detailed block diagram of an example apparatus 300 for sending e-mails (e.g., the e-mails 108a, 108b of FIG. 1) using e-mail delivery payments. In the illustrated example, the example apparatus 300 is implemented using the e-mail server 102 (FIG. 1). However, the example apparatus 300 may alternatively be separate from tie e-mail server 102. The example apparatus 300 may be implemented using any desired combination of hardware, firmware, and/or software. For example, one or more integrated circuits, discrete semiconductor components, or passive electronic components may be used. Additionally or alternatively, some or all of the blocks of the example apparatus 300, or parts thereof, may be implemented using instructions, code, and/or other software and/or firmware, etc. stored on a machine accessible medium that, when executed by, for example, a processor system (e.g., the example processor system 610 of FIG. 6), perform the operations represented in the flow diagram of FIG. 4.

To store the e-mail 108a while the example apparatus 300 determines whether an e-mail delivery payment has been deposited into the recipient account 112, the example apparatus 300 is provided with an example incoming e-mail intermediate storage structure 302. In the illustrated example, the example incoming e-mail intermediate storage structure 302 receives the e-mail 108a from the sender 104 that is addressed to the intended recipient 106. For example, the example incoming e-mail intermediate storage structure 302 may receive the e-mail 108a from an e-mail account of the sender 104 and store the e-mail 108a until the example apparatus 300 determines whether a corresponding e-mail delivery payment has been deposited into the recipient account 112.

In an alternative example implementation, the incoming e-mail intermediate storage structure 302 may be omitted from the example apparatus 300. In this case, the e-mail 108a may be received by the recipient mailbox 312 and the recipient mailbox 312 may make the e-mail 108a invisible, unviewable, and/or inaccessible to the recipient 104 until the example apparatus 300 determines whether a corresponding e-mail delivery payment has been deposited into the recipient account 112. Alternatively or additionally, the recipient mailbox 312 may categorize, file, or otherwise store the e-mail 108a in an unverified or unvalidated e-mail folder (e.g., a junk e-mail folder, a spam e-mail folder, a bulk e-mail folder, a pending e-mail folder, etc.) until the example apparatus 300 determines whether the e-mail delivery payment has been deposited into the recipient account 112.

To determine whether the e-mail 108a contains information indicating that the sender 104 has posted an e-mail delivery payment to the recipient account 112, the example apparatus is provided with an e-mail analyzer 304. The e-mail analyzer 304 is communicatively coupled to the incoming e-mail intermediate storage structure 302 and is configured to obtain and/or analyze information from the e-mail 108a. For example, the e-mail analyzer 304 may extract and/or analyze information indicating whether the sender 104 has posted an e-mail delivery payment to the recipient account 112 to enable delivery of the e-mail 108a. Also, the e-mail analyzer 304 may obtain e-mail properties from the e-mail 108a such as, for example, recipient identification information (e.g., name, username, etc.), a recipient e-mail address, sender identification information, a sender e-mail address, etc.

In the illustrated example, the e-mail analyzer 304 is also configured to access a user preferences database 306. For example, the e-mail analyzer 304 may retrieve threshold e-mail delivery payment values indicated by the recipient 106 from the user preferences database 306. In the illustrated example, the recipient 106 may assign different minimum threshold e-mail delivery payment amounts for different senders and store the threshold values in the user preferences 306 for subsequent use by the example apparatus 300 to verify (e.g., validate) e-mails and/or to block e-mail spam or unwanted e-mails. In some instances, the recipient 106 may assign a relatively low payment amount required by family and friends and a relatively high payment amount for e-mails from unknown addressees (e.g., marketing or spam e-mails). The e-mail analyzer 304 may also obtain recipient account information (e.g., an account number of the recipient account 112) from the user preferences database 306 based on the recipient identification information or recipient e-mail obtained from the e-mail 108a. Also, the e-mail analyzer 304 may retrieve wait time values (e.g., minutes, hours, days, weeks, etc.) from the user preferences database 306 indicating the amount of time to wait for the sender 104 to provide the e-mail delivery payment before discarding or deleting the e-mail 108a. The wait time value may be configurable by the recipient 104 and/or may be set to a default or standard time value.

To determine whether the e-mail delivery payment has actually been deposited into the recipient account 112, the example apparatus 300 is provided with a payment verifier 308. The payment verifier 308 is communicatively coupled to the e-mail analyzer 304 and is configured to receive information from the e-mail analyzer 304 indicating whether e-mails (e.g., the e-mail 108a) contains information indicating that the sender 104 has posted an e-mail delivery payment to the recipient account 112. In response to receiving information from the e-mail analyzer 304 indicating that the sender 104 has posted an e-mail delivery payment to the recipient account 112, the payment verifier 308 is configured to retrieve recipient account information from the e-mail analyzer 306 and/or from the user preferences database 306 and access the recipient account 112 to determine whether the payment indicated in the e-mail 108a has actually been deposited in the recipient account 112. The payment verifier 308 may also determine whether the deposited payment funds are available for withdrawal by the recipient 106 (e.g., the e-mail delivery payment is not subject to insufficient funds or fraudulent activity on behalf of the e-mail sender). This ensures that the recipient 104 will not be tricked (e.g., conned) into receiving e-mails associated with payments that were paid using fraudulent means (e.g., stolen credit cards, sender accounts having insufficient funds, etc.) for which the financial institution managing the recipient account 112 may place a hold on the funds.

In alternative example implementations, the payment verifier 308 may be configured to determine whether e-mail delivery payments have been deposited into the recipient account 112, but not whether the payment is available for withdrawal by the recipient 106. For example, this may be a recipient-selectable feature that the recipient 106 may select based on the level of scrutiny desired for incoming e-mails.

To generate payment request messages (e.g., the example payment request message 116 of FIGS. 1 and 2), the example apparatus 300 is provided with a payment status notification generator 310 that is communicatively coupled to the incoming e-mail intermediate storage structure 302, the e-mail analyzer 304, and/or the payment verifier 308. The payment status notification generator 310 generates the example payment request message 116 when it receives information or a notification from the e-mail analyzer 304 indicating that an e-mail (e.g., the e-mail 108a) does not contain information indicative that the sender 104 has posted the e-mail delivery payment to the recipient account 112. Additionally or alternatively, the payment status notification generator 310 generates the example payment request message 116 when it receives information or a notification from the payment verifier 308 indicating that an e-mail delivery payment has not been deposited in the recipient account 112 and/or is not available for withdrawal by the recipient 106. The payment status notification generator 310 may obtain the e-mail identification information 202 (FIG. 2) associated with the e-mail 108a from the incoming e-mail intermediate storage structure 302.

To store verified e-mails (e.g., the verified e-mail 108b of FIG. 1), the example apparatus 300 is provided with a recipient mailbox 312 that is communicatively coupled to the incoming e-mail intermediate storage structure 302. The incoming e-mail intermediate storage structure 302 indicates that the e-mail 108a is verified (e.g., converts the e-mail 108a into the verified e-mail 108b) by, for example, writing to a “verified” parameter in the e-mail 108a. The incoming e-mail intermediate storage structure 302 then forwards the verified e-mail 108b to the recipient mailbox 312 for storage so that the recipient 106 may subsequently retrieve the verified e-mail 108b. Specifically, the incoming e-mail intermediate storage structure 302 forwards the verified e-mail 108b to the recipient mailbox 312 when the payment verifier 308 sends information or a notification to the incoming e-mail intermediate storage 302 indicating that an e-mail delivery payment has been deposited in the recipient account 112 and/or is available for withdrawal by the recipient 106.

In an alternative example implementation, if the intermediate storage 302 is omitted from the example apparatus 300 (e.g., the recipient mailbox 312 stores the e-mail 108a until the example apparatus 300 determines whether a corresponding e-mail delivery payment has been deposited into the recipient account 112), the recipient mailbox 312 may indicate that the e-mail 108a is verified or validated (e.g., converts the e-mail 108a into the verified e-mail 108b) and make the verified e-mail 108b visible, viewable, and/or otherwise accessible to the recipient 104. Additionally or alternatively, the recipient mailbox 312 may transfer the verified e-mail 108b from an unverified or unvalidated e-mail folder (e.g., a junk e-mail folder, a spam e-mail folder, a bulk e-mail folder, a pending e-mail folder, etc.) to an inbox e-mail folder indicating that a corresponding e-mail delivery payment has been provided for the verified e-mail 108b.

In some example implementations, the incoming e-mail intermediate storage structure 302 and/or the recipient mailbox 312 may be configured to verify or validate the e-mail 108a using a digital signature, an encryption technique, or some other fraud protection technique to ensure that the sender 104 (e.g., a spammer) cannot fraudulently modify the e-mail 108a to enable delivery of the e-mail 108a without providing the required e-mail delivery payment.

To refund some or all of the e-mail delivery payment to the sender 104, the example apparatus 300 is provided with a refunder 314. When the recipient 106 retrieves the verified e-mail 108b from the recipient mailbox 312, the recipient 106 may elect to refund all or at least a portion of the e-mail delivery payment to the sender 104. In particular, the recipient 106 may select a refund option via an e-mail terminal (e.g., one of the e-mail terminals 152, 154, 156, 158, or 160 of FIG. 1) that causes the refunder 314 to communicate with the refund mechanism 114 at the recipient account 112 to refund a portion or all of the e-mail delivery payment deposited into the recipient account 112 to the sender account 110.

To deliver the e-mail 108a to a plurality of recipients listed in a “To:” field and a “Cc:” field of the e-mail 108a, the sender 104 must provide a plurality of e-mail delivery payments, each of which corresponds to a respective intended recipient. That is, the sender 104 must deposit an e-mail delivery payment in the funds account of each the listed recipients. In this manner, the example apparatus 300 or a plurality of apparatus substantially similar or identical to the example apparatus 300 can verify or confirm that the sender 104 has posted the e-mail delivery payments and that the e-mail delivery payments have actually been deposited in the recipient accounts and/or are available for withdrawal by the intended recipients. If the sender 108a has provided the e-mail delivery payment to only some of the listed recipients, then the example apparatus 300 may deliver the verified e-mail 108b only to those recipients for which the payment was provided. Each of the recipients that receive the verified e-mail 108b can then elect whether to refund the e-mail delivery payment deposited into their respective account back to the sender 104. In some cases, only some of the recipients may elect to refund the e-mail delivery payment to the sender 104.

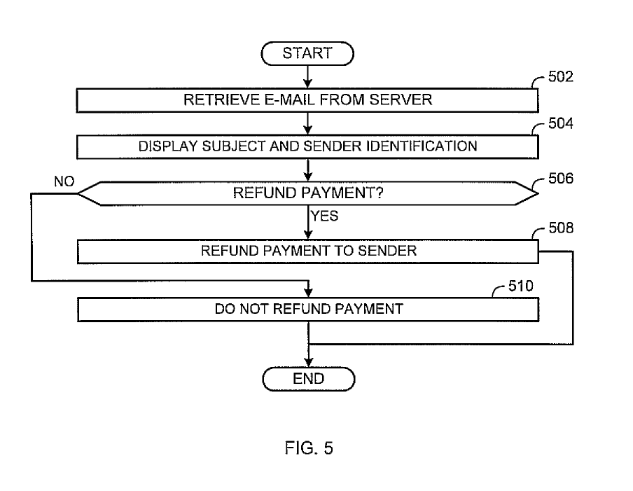

Flowcharts representative of example machine readable instructions for implementing the example apparatus 300 of FIG. 3 and/or other apparatus such as, for example, an e-mail terminal or client (e.g., a computer 152, a mobile phone 154, a personal digital assistant 156, a wireless communicator 158, a web-based e-mail service 160, etc.) and the refund mechanism 114 communicatively coupled to the example apparatus 300, In these examples, the machine readable instructions comprise one or more programs for execution by one or more processors such as the processor 612 shown in the example processor system 610 of FIG. 6. The programs may be embodied in software stored on tangible mediums such as CD-ROM's, floppy disks, hard drives, digital versatile disks (DVD's), or a memory associated with the processor 612 and/or embodied in firmware and/or dedicated hardware in a well-known manner. For example, any or all of the example apparatus 300, the incoming e-mail intermediate storage 302, the e-mail analyzer 304, the user preferences 306, the payment verifier 308, the payment status notification generator 310, the recipient mailbox 312, the refunder 314, the refund mechanism 114, e-mail terminals, and/or e-mail clients could be implemented using software, hardware, and/or firmware. Further, although the example program is described with reference to the flowcharts illustrated in FIGS. 4 and 5, persons of ordinary skill in the art will readily appreciate that many other methods of implementing the example apparatus 300 and other apparatus communicatively coupled thereto may alternatively be used. For example, the order of execution of the blocks may be changed, and/or some of the blocks described may be changed, eliminated, or combined.

As shown in FIG. 4, initially the e-mail server 102 (FIG. 1) obtains the e-mail 108a (FIGS. 1 and 3) (block 402). In the illustrated example, the sender 104 (FIGS. 1 and 3) has sent the e-mail 108a, which is addressed to the intended recipient 106 (FIGS. 1 and 3). The incoming e-mail intermediate storage structure 302 (FIG. 3) of the illustrated example then stores the e-mail 108b (block 404). In this manner, the example apparatus 300 can determine whether the sender 104 has posted an e-mail delivery payment to the recipient account 112 and whether the e-mail delivery payment has actually been deposited and/or is available for withdrawal by the recipient 106 prior to delivering the e-mail to the recipient 106. In an alternative example implementation in which the intermediate storage 302 is omitted from the example apparatus 300, at block 404 the recipient mailbox 312 may store the e-mail 108a until the example apparatus 300 determines whether the e-mail delivery payment has been deposited into the recipient account 112. In this case, the recipient mailbox 312 may male the e-mail 108a invisible, unviewable, and/or inaccessible to the recipient 104 and/or may categorize, file, or otherwise store the e-mail 108a in an unverified or unvalidated e-mail folder (e.g., a junk e-mail folder, a spam e-mail folder, a bulk e-mail folder, a pending e-mail folder, etc.) until the example apparatus 300 determines whether the e-mail delivery payment has been deposited into the recipient account 112.

The e-mail analyzer 304 of the illustrated example then retrieves the intended recipient identification information (block 406) and the sender identification information (block 408) from the e-mail 108a stored in the incoming e-mail intermediate storage structure 302. The e-mail analyzer 304 then retrieves the amount of required payment for delivery of the e-mail 108a (block 410). For example, the e-mail analyzer 304 may use the recipient and sender information to retrieve a minimum threshold payment amount from the user preferences database 306 (FIG. 3) that the intended recipient 106 requires of the sender 104 to enable delivery of the e-mail 108a. The minimum threshold payment amount corresponding to the sender 104 may be different from another minimum threshold payment amount that the intended recipient 106 requires of another user. For example, the recipient 106 may elect to require a smaller payment from friends and family and a larger payment from marketing companies, businesses, spammers, etc. It is preferred, however, that at least some payment is required for all or substantially all e-mails.

The e-mail analyzer 108a then retrieves the account number of the intended recipient 106 (block 412) that can be used to verify deposit of the e-mail delivery payment in the recipient account 112 (FIGS. 1 and 3). The payment verifier 308 (FIG. 3) then retrieves deposit transaction information for the recipient account 112 (block 414) by, for example, requesting such information from the financial institution that manages the recipient account 112. The payment verifier 308 then determines whether a deposit transaction corresponding to the received e-mail 108a has been generated (block 416). If a deposit transaction corresponding to the received e-mail 108a exists (block 416), then the payment verifier 308 determines whether the deposit amount of the deposit transaction is sufficient (block 418) based on the retrieved minimum threshold amount retrieved at block 410. For example, the payment verifier 308 may include a comparator (not shown) that compares the deposit amount to the minimum threshold amount and outputs a signal indicating whether the deposit amount is sufficient.

If the deposit amount is sufficient (block 418), then the payment verifier 308 determines whether the funds from the deposit transaction are available for withdrawal (block 420) by the recipient 106. For example, the payment verifier 308 may query the recipient account 112 and/or the managing financial institution to determine if any holds have been put on the hinds (e.g., due to fraudulent transaction, insufficient sender funds, etc.) or if for any other reason the recipient 106 would be prevented from withdrawing the funds corresponding to the e-mail delivery payment. In some example implementations, determining that the funds from the deposit transaction are available for withdrawal (block 420) ensures that the recipient 106 can obtain the funds associated with the e-mail delivery payment and use the funds for purposes other than sending e-mail messages. For example, the funds may be withdrawn as cash currency that the recipient 106 may spend as desired. Alternatively, the account may be a credit card account, a debit card account, a credit union account, etc.

If the funds from the deposit transaction are not available for withdrawal (block 420) or if the payment verifier 308 determines that a deposit transaction corresponding to the received e-mail 108a does not exist (block 416) or if the payment verifier 308 determines that the deposit amount of the deposit transaction is not sufficient (block 418), then the payment status notification generator 310 generates the example payment request message 116 (FIGS. 1 and 2) and forwards the message 116 to the sender 104 (block 422). After the payment status notification generator 310 forwards the example payment request message 116 to the sender 104, the payment verifier 308 determines whether it has received a funds availability notice from the recipient account 112 (block 424). For example, the payment verifier 308 may retrieve a user-specified timer value from the user preferences database 306 and set a timer for an amount of time that it will wait for the sender 104 to provide the required e-mail delivery payment.

If the payment verifier 308 has not yet received a funds availability notice from the recipient account 112 (block 424), then the payment verifier 308 determines if the wait time has expired (block 426). If the wait time has not expired (block 426), then control returns to block 424. However, if the payment verifier 308 has received a funds availability notice from the recipient account 112 (block 424), then the payment verifier 308 determines if the funds are sufficient (block 428) in a manner similar to that described above in connection with block 418.

If the payment verifier 308 determines that the funds are not sufficient (block 428) or if the payment verifier 308 determines that the wait time has expired (block 426), then the incoming e-mail intermediate storage structure 302 discards (e.g., deletes) the e-mail 108a (block 430). In an example implementation in which the incoming e-mail intermediate storage structure 302 is omitted from the example apparatus 300, (e.g., the recipient mailbox 312 stores the e-mail 108a until the example apparatus 300 determines whether a corresponding e-mail delivery payment has been deposited into the recipient account 112), at block 430 the recipient mailbox 312 may discard (e.g., delete) the e-mail 108a. In some example implementations, the incoming e-mail intermediate storage structure 302 (or the recipient mailbox 312) may return the e-mail 108a to the sender 104.

If, instead, the payment verifier 308 determines that the funds are sufficient (block 428) or if at block 420 the payment verifier 308 determines that the funds from the deposit transaction are available for withdrawal, then the incoming e-mail intermediate storage structure 302 indicates that the e-mail 108a is verified (block 432) (e.g., converts the e-mail 108a into the verified e-mail 108b) by, for example, writing to a “verified” parameter in the e-mail 108a. In some example implementations, the incoming e-mail intermediate storage structure 302 may be configured to verify or validate the e-mail 108a using a digital signature, an encryption technique, or some other fraud protection technique to ensure that the sender 104 (e.g., a spammer) cannot fraudulently modify the e-mail 108a to enable delivery of the e-mail 108a without providing the required e-mail delivery payment.

The incoming e-mail intermediate storage structure 302 then forwards the verified e-mail 108b to the recipient mailbox 312 (block 434) for storage so that the recipient 106 may subsequently retrieve the verified e-mail 108b. In an alternative example implementation in which the intermediate storage 302 is omitted from the example apparatus 300 (e.g., the recipient mailbox 312 stores the e-mail 108a until the example apparatus 300 determines whether a corresponding e-mail delivery payment has been deposited into the recipient account 112), at block 432 the recipient mailbox 312 may indicate that the e-mail 108a is verified or validated (e.g., converts the e-mail 108a into the verified e-mail 108b) and at block 434 the recipient mailbox 312 may make the verified e-mail 108b visible, viewable, and/or otherwise accessible to the recipient 104. Additionally or alternatively, at block 434 the recipient mailbox 312 may transfer the verified e-mail 108b from an unverified or unvalidated e-mail folder (e.g., a junk e-mail folder, a spam e-mail folder, a bulk e-mail folder, a pending e-mail folder, etc.) to an inbox e-mail folder or main e-mail folder.

At blocks 432 and 434, the incoming e-mail intermediate storage structure 302 verifies and forwards the verified e-mail 108b to the recipient mailbox 312 (and/or the recipient mailbox 312 verifies and makes accessible the verified e-mail 108b) without requiring a check or an analysis of a permissions list of the recipient 106. Therefore, provided the required payment is made, the incoming e-mail intermediate storage structure 302 verifies and forwards the verified e-mail 108b to the recipient mailbox 312 regardless of whether the permissions list of the recipient 106 contains an e-mail address or other information identifying the sender 104. The process is then ended. Of course, the process may be repeated for any other received e-mails.

The example flowchart depicted in FIG. 5 is representative of machine readable instructions that may be executed by an e-mail terminal or client (e.g., a computer 152, a mobile phone 154, a personal digital assistant 156, a wireless communicator 158, a web-based e-mail service 160, etc.) to enable an e-mail recipient (e.g., the recipient 106 of FIGS. 1 and 3) to grant or withhold refunding of payment to an e-mail sender (e.g., the sender 104 of FIGS. 1 and 3). As shown, first the recipient 106 retrieves the e-mail 108b from the e-mail server 102 (FIG. 1) (block 502) using, for example, an e-mail terminal. The e-mail terminal then displays the e-mail subject information and the sender identification information (e.g., a sender name, a sender username, a sender e-mail address, etc.) (block 504). The e-mail terminal then determines whether the recipient 106 has elected to refund the e-mail delivery payment (block 506) associated with the e-mail 108b. If the e-mail terminal determines that the recipient has elected to refund the e-mail delivery payment (block 506), then the e-mail delivery payment is refunded to the sender account 110 (FIGS. 1 and 3) (block 508). In particular, the e-mail terminal causes the refunder 314 (FIG. 3) to communicate with the refund mechanism 114 (FIGS. 1 and 3) at the recipient account 112 (FIGS. 1 and 3) to refund the e-mail delivery payment (block 508) to the sender account 110. At block 508, the recipient 106 may elect to refund all of the e-mail delivery payment or only a portion thereof.

Otherwise, if the e-mail terminal determines that the recipient 106 has elected not to refund the e-mail delivery payment (block 506), the e-mail delivery payment is not refunded (block 510) to the sender account 110. After block 508 or block 510, the process of FIG. 5 is ended. Of course, the process may be repeated for any other received e-mail.

FIG. 6 is a block diagram of an example processor system that may be used to implement the example apparatus, methods, and articles of manufacture described herein. As shown in FIG. 6, the processor system 610 includes a processor 612 that is coupled to an interconnection bus 614. The processor 612 includes a register set or register space 616, which is depicted in FIG. 6 as being entirely on-chip, but which could alternatively be located entirely or partially off-chip and directly coupled to the processor 612 via dedicated electrical connections and/or via the interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. A chipset provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a digital subscriber line (DSL) modem, a cable modem, a cellular modem, etc. that enables the processor system 610 to communicate with another processor system.

While the memory controller 620 and the I/O controller 622 are depicted in FIG. 6 as separate functional blocks within the chipset 618, the functions performed by these blocks may be integrated within a single semiconductor circuit or may be implemented using two or more separate integrated circuits.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above-described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such devices are periodically superseded by faster or more efficient systems having the same general purpose. Accordingly, replacement devices, standards and/or protocols having the same general functions are equivalents which are intended to be included within the scope of the accompanying claims.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method, comprising:
receiving an electronic mail message at a server;
determining whether the electronic mail message includes information indicative that a sending entity has posted an electronic mail delivery payment to enable delivery of the electronic mail message;
when the electronic mail message includes the information indicative that the sending entity has posted the electronic mail delivery payment, polling a funds account of an intended recipient of the electronic mail message to determine whether the electronic mail delivery payment has been deposited in the funds account; and
not sending the electronic mail message to a mailbox of the intended recipient unless the electronic mail delivery payment has been deposited in the funds account regardless of whether the sending entity is on a permissions list.

2. A method as defined in claim 1, wherein the electronic mail delivery payment has a monetary value.

3. A method as defined in claim 1, further comprising not sending another electronic mail message to the mailbox of the intended recipient when the other electronic mail message does not include the information indicative that another sending entity has posted another electronic mail delivery payment.

4. A method as defined in claim 1, further comprising sending the electronic mail message to the mailbox of the intended recipient when the electronic mail delivery payment has been deposited in the funds account.

5. A method as defined in claim 1, wherein the fund account is at least one of a bank account, a credit card account, a debit card account, a credit union account, or an Internet payment system account of the recipient.

6. A method as defined in claim 1, wherein determining whether the electronic mail delivery payment has been deposited in the funds account includes determining whether the amount of the electronic mail delivery payment is equal to or greater than a threshold value associated with the intended recipient.

7. A method as defined in claim 6, wherein the amount of the threshold value is selectable by the intended recipient to designate the minimum amount of the electronic delivery payment required by the sending entity, and wherein the threshold value is different from another threshold value selected by the intended recipient for another sending entity.

8. A method as defined in claim 6, wherein determining whether the electronic mail delivery payment has been deposited in the funds account comprises determining whether the electronic mail delivery payment is available for withdrawal by the intended recipient.

9. An apparatus comprising:
an electronic mail storage area to store the electronic mail;
a payment verifier to poll a funds account of an intended recipient to determine whether an electronic mail delivery payment has been deposited in the funds account to enable delivery of an electronic mail message to the intended recipient; and
a notification generator configured to send a notification to a sending entity of the electronic mail message to request the electronic mail delivery payment when the payment verifier determines that the electronic mail delivery payment has not been deposited in the funds account regardless of whether the sending entity is on a permissions list.

10. An apparatus as defined in claim 9, further comprising an e-mail analyzer communicatively coupled to the electronic mail storage area to determine whether the electronic mail message includes information indicative that the sending entity has posted the electronic mail delivery payment to the funds account of the intended recipient of the electronic mail message to enable delivery of the electronic mail message.

11. An apparatus as defined in claim 10, wherein the notification generator is configured to send the notification when the e-mail analyzer determines that the sending entity has not posted the electronic mail delivery payment to the funds account.

12. An apparatus as defined in claim 9, wherein the notification generator is configured to send the notification when the payment verifier determines that the mail delivery payment is not available for withdrawal from the funds account.

13. An apparatus as defined in claim 9, further comprising a recipient mailbox communicatively coupled to the electronic mail storage space to receive the electronic mail from the electronic mail storage space only if the payment verifier determines that the electronic delivery payment has been at least one of deposited in the funds account or available for withdrawal from the funds account.

14. An apparatus as defined in claim 9, further comprising a refunder configured to refund at least a portion of the electronic mail delivery payment to the sending entity when the intended recipient elects to refund the at least the portion of the electronic mail delivery payment.

15. A machine accessible medium having instructions stored thereon that, when executed, cause a machine to:
receive an electronic mail message at a server;
determine whether the electronic mail message includes information indicative that a sending entity has posted an electronic mail delivery payment to enable delivery of the electronic mail message;
when the electronic mail message includes the information indicative that the sending entity has posted the electronic mail delivery payment, poll a funds account of an intended recipient of the electronic mail message to determine whether the electronic mail delivery payment has been deposited in the funds account; and
conditionally sending the electronic mail message to a mailbox of the intended recipient based on whether the electronic mail delivery payment has been deposited in the funds account regardless of whether the sending entity is on a permissions list.

16. A machine accessible medium as defined in claim 15, wherein the electronic mail delivery payment has a monetary value.

17. A machine accessible medium as defined in claim 15 having instructions stored thereon that, when executed, cause the machine to not send the electronic mail message to the mailbox of the intended recipient when the electronic mail message does not include the information indicative that the sending entity has posted the electronic mail delivery payment.

18. A machine accessible medium as defined in claim 15 having instructions stored thereon that, when executed, cause the machine to send the electronic mail message to the mailbox of the intended recipient when the electronic mail delivery payment has been deposited in the funds account.

19. A machine accessible medium as defined in claim 15, wherein the funds account is at least one of a bank account, a credit card account, a debit card account a credit union account, or an Internet payment system account of the recipient.

20. A machine accessible medium as defined in claim 15 having instructions stored thereon that, when executed, cause the machine to determine whether the electronic mail delivery payment has been deposited in the funds account by determining whether the amount of the electronic mail delivery payment is equal to or greater than a threshold value associated with the intended recipient.

21. A machine accessible medium as defined in claim 20 having instructions stored thereon that, when executed, cause the machine to retrieve the threshold value based on identification information corresponding to the sending entity, wherein the threshold value is different from another threshold value corresponding to another sending entity.

22. A machine accessible medium as defined in claim 20 having instructions stored thereon that, when executed, cause the machine to determine whether the electronic mail delivery payment has been deposited in the funds account by determining whether the electronic mail delivery payment is available for withdrawal by the intended recipient.

23. A method, comprising:
receiving an electronic message;
determining whether a monetary amount associated with delivering the electronic message has been deposited in an account;
determining whether the monetary amount is available for withdrawal by the intended recipient of the electronic message; and
delivering the electronic message to the intended recipient if the monetary amount is available for withdrawal by the intended recipient of the electronic message.

24. A method as defined in claim 23, further comprising not delivering the electronic message to the intended recipient if the monetary amount has not been deposited in the account.

25. A method as defined in claim 24, wherein not delivering the electronic message comprises not delivering the electronic mail message regardless of whether a permissions list contains an electronic mail address of a sender of the electronic message.

26. A method as defined in claim 23, wherein determining whether the monetary amount has been deposited in the account comprises determining whether the monetary amount is equal to or greater than the a threshold amount.

27. A method as defined in claim 26, wherein the threshold amount is adjustable.

28. A method as defined in claim 23, wherein the monetary amount is refundable to a sender of the electronic message by the intended recipient of the electronic message.

29. A method as defined in claim 23, wherein delivering the electronic message to the intended recipient if the monetary amount is available for withdrawal by the intended recipient comprises delivering the electronic message to the intended recipient without checking a permissions list.

30. A method as defined in claim 23, wherein delivering the electronic message to the intended recipient if the monetary amount is available for withdrawal by the intended recipient comprises delivering the electronic message to the intended recipient regardless of whether a permissions list contains identification information of a sender of the electronic mail message.
